(19) United States
(12) Patent Application Publication
(10) Pub. No.: US 2018/0095690 A1
(43) Pub. Date: Apr. 5, 2018

(54) CREATING VIRTUAL STORAGE VOLUMES IN STORAGE SYSTEMS

(71) Applicant: Hewlett Packard Enterprise Development LP, Houston, TX (US)

(72) Inventor: Matthew Gates, Houston, TX (US)

(21) Appl. No.: 15/282,136

(22) Filed: Sep. 30, 2016

(51) Int. Cl. G06F 3/06; G06F 17/30

(52) U.S. Cl. CPC G06F 3/0632; G06F 3/0604; G06F 3/0631; G06F 3/0644; G06F 17/30575; G06F 3/0665; G06F 3/0683; G06F 17/30377; G06F 3/065

(57) ABSTRACT

Examples include provision by a processing resource of a computing device, of a first entry in a database in a storage system of the computing device. The first entry points to a mapping table pointing to physical data blocks allocating a virtual storage volume in the storage system. Entries of the mapping table comprise a shared flag that when set indicates that a physical data block pointed by the entry is pointed by at least one more entry of the mapping table or of another mapping table. Some examples include creation by the processing resource, of a second entry in the database pointing to the same mapping table and set of the shared flag of the first and second entries indicating that the virtual storage volume is shared.

### BACKGROUND

In computing environments, amount of data that need to be stored in data storage systems has drastically increased in these years while data storage systems have limited resources. In order to more efficiently storing data in the data storage systems, the storage may be allocated by a technique called “storage virtualization”, and more particularly by techniques such as “thin provisioning”. Storage virtualization abstracts logical storage from physical storage, such that data that is stored with respect to the physical storage may be accessed via the virtual storage without regard to the structure of the physical storage.

### BRIEF DESCRIPTION OF THE DRAWINGS

Certain examples are described in the following detailed description and in reference to the drawings, in which:

FIG. 1 is a flowchart of an example method for creating a virtual storage volume by coping the mapping table pointing to an existing virtual storage volume.

FIG. 2 is a flowchart of another example method for creating a virtual storage volume by coping the mapping table for the virtual storage volume, including receiving a request to modify a shared physical data block.

FIG. 3 is a block diagram of an example system for creating a virtual storage volume by coping the mapping table for the virtual storage volume.

FIG. 4 is a block diagram of an example mapping table pointing to a virtual storage volume.

FIGS. 5A-5D are block diagrams of an example method for copying and modifying an existing physical data block by copying the mapping table pointing to the physical data block.

FIG. 6 is a block diagram of an example computing system for creating a virtual storage volume by coping the mapping table pointing to an existing virtual storage volume.

### DETAILED DESCRIPTION

As the amount of information treated in computer systems is drastically increased, the capacity of a storage device, such as a disk for storage of data, has been steadily increased. Efficient management of data storage that uses virtualization technology to give the appearance of having more storage space than is actually available, is becoming essential in modern data storage systems. In particular, thin provisioning is a virtualization technology that allows virtual volumes to be provisioned with a larger number of virtual blocks than actually exists on the physical storage devices. The virtual blocks are allocated from an underlying pool of physical storage on-demand, as the host writes data to previously unwritten virtual blocks on the virtual volume.

In data storage management, a logical block (LB) is a group of storage bytes on a storage device that are manipulated as units and that are presented to a host for read and write operations to a virtual storage volume. A logical block typically contains multiple bytes of data, for example, a power of two. Example logical block sizes include 512 bytes or 4096 bytes, although the size can vary. Logical blocks are allocated into physical data blocks. Physical data blocks are units of storage as allocated on an underlying physical storage device. There may be multiple logical blocks allocated in a single physical data block. The number of logical blocks per physical data block may be a power of two. Logical blocks are accessed through a logical block address (LBA) within the containing physical data block. A logical storage volume or virtual storage volume is formed by a plurality of logical blocks.

As used herein, a data page is a logical block extent which is storing metadata or user data, for example filesystem object contents or other data with different storage formats, for a virtual storage volume allocated from a virtual storage pool. Each physical data block comprising a virtual storage volume maps to exactly one underlying data page on a virtual storage volume if the physical data block is mapped.

A virtualized storage device may maintain metadata about the mappings between host LBAs and the actual locations on disk (if any) where those LBAs' data is stored. This metadata can sometimes be updated in the I/O path, so changes to the metadata must be done in an efficient manner to achieve good performance on host I/O requests to the device.

When data storage devices support multiple virtual storage volumes, for example thin-provisioned logical volumes, it may be desirable to create a copy of a particular virtual storage volume. For example, a copy of a virtual storage volume may be needed in order to support snapshots or clones of virtual storage volumes. Snapshots are point-in-time replicas of virtual storage volumes or other snapshots. From a mapping perspective, a snapshot is equivalent to a virtual storage volume. Snapshots initially share all allocated data pages with their parent virtual storage volume. As writes occur to either the parent virtual storage volume, additional pages can be allocated to preserve the original data for the snapshot volume. Similarly, if writes occur to a snapshot which is storing a data page with its parent virtual storage volume, a new data page is to be allocated to store the new data written to the snapshot. Clones are fully provisioned copies of virtual storage volumes while snapshots are generally thinly provisioned copies, e.g. only deltas from the original virtual storage volume are stored, not a complete copy.

Examples described herein may provide a method for creating virtual storage volumes in a storage system, the virtual storage volumes being included in physical data blocks. The storage system may create the virtual storage volumes by copying a mapping table of an existing virtual storage volume, the mapping table storing metadata including pointers, such as addresses, states, flags, etc., to the physical data blocks including the virtual storage volume. The storage system may further set a shared flag in all valid entries in both the original virtual storage volume's mapping table and the copy. This may effectively create a new virtual storage volume that shares all its underlying metadata and physical data blocks with the original virtual storage volume. As either virtual storage volume is modified, the storage system may identify the shared flag set and may perform copy-on-write operations to make private copies of the physical data blocks. The physical data blocks may store metadata, data contents of filesystem objects, such as files, folders, etc. or a combination thereof. Thus, the data stored in the original and the copied physical data blocks and therefore, in the corresponding virtual storage volumes, may diverge over time as changes are made.

The copying of the mapping table of a virtual storage volume provides an efficient way to implement snapshots and clones of the virtual storage volumes, for example thin-provisioned volumes, which is a competitive requirement for enterprise-class storage systems, and provide improvements in terms of user experience. In such examples, entries in a database of the storage system, for example a system-wide database, may be provided, wherein each one of the entries may point to a particular mapping table pointing to corresponding physical data blocks comprising virtual storage volumes in the storage system. The entries of each one of the mapping tables may comprise a shared flag that when set indicates that a physical data block pointed by the particular entry having the set shared flag is pointed by at least one more entry of a mapping table. In some examples, the shared flag may be a single bit located somewhere in each one of the entries of the mapping table and in the entries in the database of the storage system.

Entries pointing to a common physical data block may belong to the same mapping table (the common physical data block is pointed by at least two entries of the mapping table pointing to a single virtual storage volume) or may belong to different mapping tables (the common physical data block is pointed by entries of more than one mapping tables pointing to different virtual storage volumes). Such examples may comprise creating a new entry for each one of the existing entries of the database. The new entries may point to the same mapping table the corresponding existing entries point to. Then, the shared flag of the existing and the new entries in the database may be set such that the set shared flag indicates that mapping table for both virtual storage volumes is shared. These changes in the database may be automatically performed such that for a user of a computing system having the storage system, the changes will appear nearly instantaneous. Once a new entry is created in the database for each one of the existing entries and the shared flag is set for both entries, the new entry and the existing one, the system may be ready to copy the physical data blocks whenever a request to modify any of the physical data blocks is received. This process guarantees the creation of the virtual storage volume is deferred and done “just-in-time” versus being done up-front.

In some other examples, in response to a request to modify a particular shared physical data block, the method may further comprise creating a copy of the particular physical data block in a new location on the storage system and modifying the copy of the physical data block according to the request received. The request to modify the particular shared data block may be a request to modify a metadata or a data content of the physical data block. Then, the method may create a copy of the mapping table pointing to the particular physical data block, wherein entries of the copy of the mapping table point to the copy of the particular physical block and clear the shared flag from entries of the mapping table pointing to the particular physical data block.

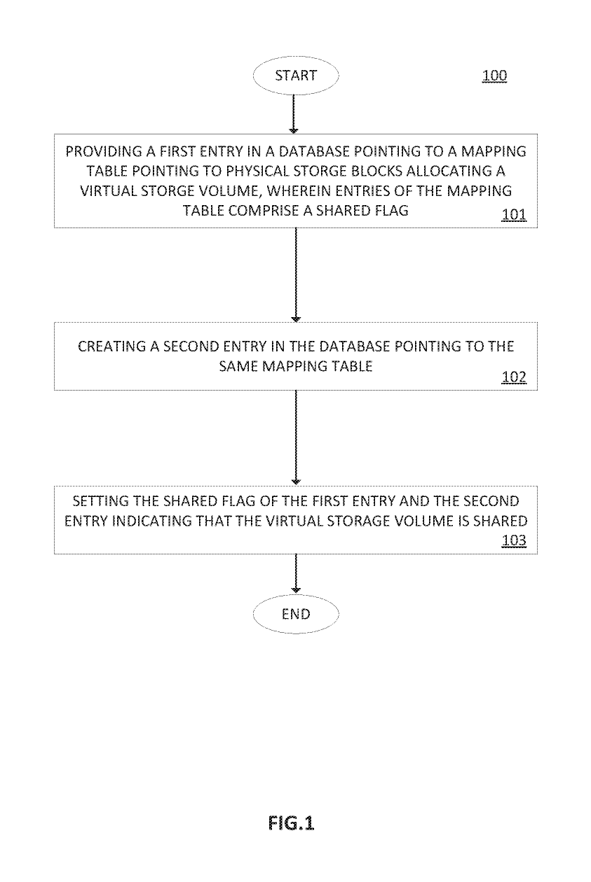

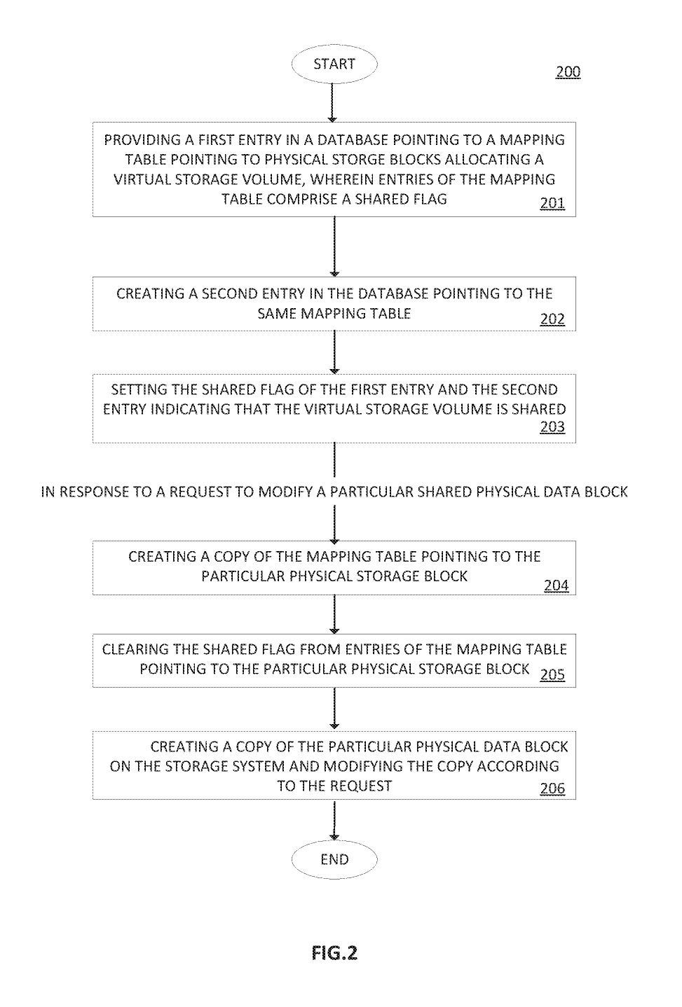

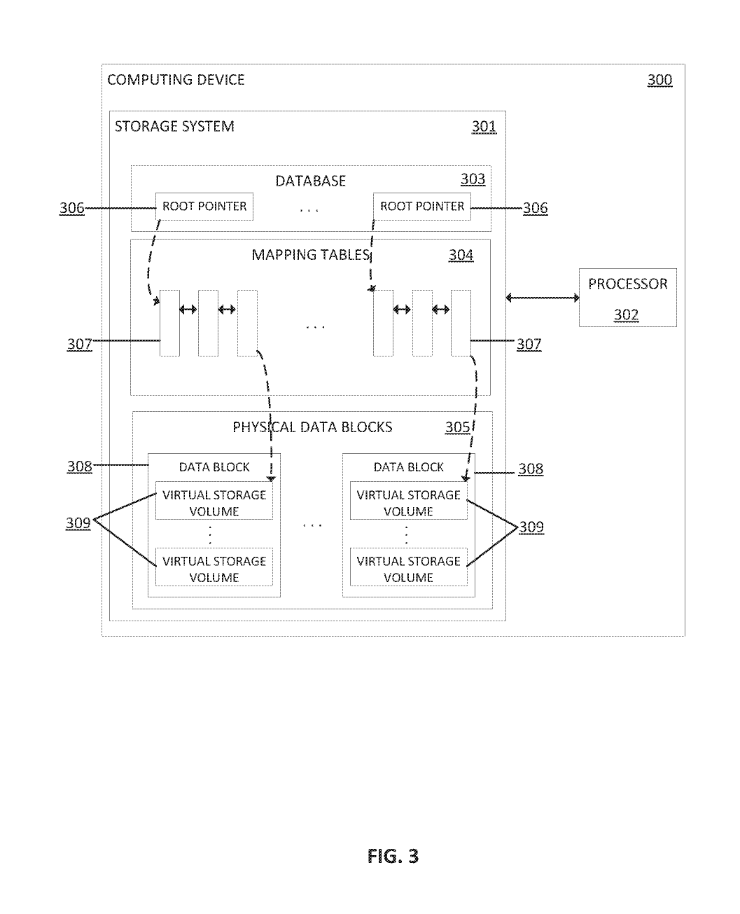

Referring now to the drawings, FIG. 1 is a flowchart of an example method 100 for creating a virtual storage volume by coping the corresponding mapping table pointing to an existing virtual storage volume. Although execution of the methods of FIGS. 1 and 2 are described in relation to computing device 300 of FIG. 3, it is contemplated that the methods of FIGS. 1 and 2 may be executed on any suitable system or devices. The methods of FIGS. 1 and 2 may be implemented as processor-executable instructions stored on a non-transitory computer-readable medium or in the form of electronic circuitry. The specific sequences of operations described in relation to FIGS. 1 and 2 are not intended to be limiting, and implementations not containing the particular orders of operations depicted in FIGS. 1 and 2 may still be consistent with the examples shown in FIGS. 1 and 2.

At 101 of method 100, entries in a database 303 in a storage system 301 of a computing device 300 are provided. Each virtual storage volume 309 in the storage system 301 has an entry, hereinafter referred to as “Root Pointer” 306, in the database 303 which may store the address of a mapping table 307 of that virtual storage volume 309. The root pointers 306 are provided to the database 303 by means of a processing resource, for example a processor 302, of the computing device 300. Root pointers 306 comprise a first root pointer 306-A that points to a mapping table 307 for the respective virtual storage volume 309, and thus ultimately to the physical storage block 308 storing data for a logical block of the virtual storage volume 309, in the storage system 301. In particular, each one of the entries of the mapping table 307 may provide the physical data block address associated with a single logical data block extent within the storage volume 309. Entries of the mapping table 307 comprise a shared flag that when set indicates that a physical data block 308 corresponding to the mapping table 307 is pointed by at least one more entry of the mapping table 307 or of another mapping table 307. Therefore, when the shared flag is set, it indicates that the corresponding physical data block 308 in which the virtual storage volume 309 is included, is shared. In some examples the database 303 may be a system-wide database. In some other examples, the mapping table 307 may be a multi-level mapping table wherein each entry in the mapping table 307 contains a pointer to the next-highest level of the mapping table 307. In such examples, the lowest level of the mapping table 307 is pointed by the corresponding root pointer 306 while the highest level of the mapping table 307 contains pointers to the respective virtual storage volumes 309, and thus to the underlying physical data blocks 308.

At 102 of the method 100, the processing resource 302 creates a new entry, for example a second root pointer 306-B, for each one of the existing first root pointers 306-A in the database 306 wherein the second root pointer 306-B points to the same mapping table 307 the corresponding first root pointer 306-A points to. The first root pointer 306-A, the second root pointer 306-B and each entry in the mapping table 307 contain a shared flag that indicates whether the corresponding physical data block 308, pointed to by any of the pointers and entries is referenced by multiple mapping table entries, for example by multiple entries of the mapping table 307 of a single virtual storage volume 309 or by entries of mapping tables 307 of multiple virtual storage volumes 309. At 103 of the method 100, the processing resource 302 sets the shared flag of all the respective first root pointers 306-A and second root pointers 306-B indicating that the virtual storage volumes 309 pointed by the mapping tables 307, to which the pairs of first root pointers 306-A and second root pointers 306-B point, are shared. At this point of the process, the storage system 301 is ready to copy any of the physical data blocks 308 comprising the virtual storage volumes 309 whenever a request to modify any of the physical data blocks 308 is received.

In some examples, when the storage system 301 receives a request to modify a metadata or data content from a virtual storage volume 309 whose mapping table entries have the shared flag set, the storage system 301 may copy the respective physical data block 308 to a new location on the underlying storage system 301 in order to create a private copy (this process is often called Copy-on-Write).

As used herein, a “computing device” may be a desktop computer, laptop (or notebook) computer, workstation, tablet computer, mobile phone, smart device, switch, router, server, blade enclosure, or any other processing device or equipment including a processing resource. In examples described herein, a processing resource may include, for example, one processor or multiple processors included in a single computing device or distributed across multiple computing devices.

As used herein, a “processing resource” may be at least one of a central processing unit (CPU); a semiconductor-based microprocessor; a graphics processing unit (GPU), a field-programmable gate array (FPGA) configured to retrieve and execute instructions, other electronic circuitry suitable for the retrieval and execution instructions stored on a machine-readable storage medium, or a combination thereof.

In some examples, functionalities described herein in relation to FIG. 1 may be provided in combination with functionalities described herein in relation to any of FIGS. 2 to 6.

FIG. 2 is a flowchart of another example method 200 for creating a virtual storage volume by coping the mapping table for the virtual storage volume, including receiving a request to modify a shared physical data block.

At 201 of method 200, first root pointers 306-A in a database 303 in a storage system 301 of a computing device 300 are provided wherein each first root pointer 306-A stores an address pointing to a mapping table 307 of a particular virtual storage volume 309. The entries of the mapping tables 307 comprise a shared flag that when set indicates that the corresponding physical data block 308, pointed by the mapping table 307 is shared.

At 202 of the method 200, the processing resource 302 creates a second root pointer 306-B for each one of the exiting first root pointers 306-A in the database 303 wherein, said second root pointer 306-B points to the same mapping table 307 the corresponding first root pointer 306-A points to. At 203 of the method 200, the processing resource 302 sets the shared flag of all the respective first root pointers 306-A and second root pointers 306-B indicating that the virtual storage volume 309 is shared. Then, a request to modify a particular shared physical data block 308 is received in the storage system 301. The request may contain an LBA extent on the virtual storage volume to be modified and the new data to be placed in that LBA extent. The request may comprise overwriting the respective physical data block 308, appending data to the physical data block 308 or cancelling data from the physical data block 308. When the root pointer 306 of the mapping table 307 identified in the request has its shared flag set, a copy-on-write process is triggered by the processing resource 302.

The shared flag set on the root pointer 306 of either virtual storage volume 309 may cause a copy-on-write operation to occur for the mapping table 307 of the virtual storage volume 309. The copy-on-write operation comprises creating 204 by the processing unit 302, a copy of the mapping table 307 pointing to the particular shared physical data block 308, wherein entries of the copy of the mapping table 307 point to the copy of the particular shared physical block 308. The second root pointer 306-B remains pointing to the original mapping table 307, while the first root pointer 306-A points to the copied mapping table 307. Finally, the processing resource 302 clears 205 the shared flag from entries of the mapping table 307 pointing to the particular shared physical data block 308. Then, the processing unit 302 creates 206 a copy of the particular shared physical data block 308 that includes the virtual storage volume 309 in a new location on the storage system 301 and modifying the copy of the physical data block 308 according to the request received.

In some examples, the mapping table 307 may be a multi-level mapping table. The number of levels in the mapping table may vary depending on the specific implementation of the mapping table. Entries of the multi-level mapping table may comprise pointers to an immediately higher level of the multi-level mapping table. Entries of a highest level of the mapping table 307 may store pointers to the physical data blocks 308 and entries of the lowest level of the mapping table 307 may be pointed by the respective root pointer 306 of the virtual storage volume 309. In such examples, the copy-on-write operation of the multi-level mapping table may be carried out level by level. Thus, in response to a request to modify a particular shared physical data block 308 including the respective virtual storage volume 309, the processing resource 302 may copy a lowest mapping page corresponding to a lowest level of the mapping table 307 of the particular shared physical data block 308, may clear the shared flag from the first and second entries of the database 303 and may set the shared flag on every mapping table entry in the copied lowest mapping page. For each intermediate level of the mapping table 307, the processing resource 302 may copy an intermediate mapping page corresponding to an intermediate level of the mapping table 307, may cause a immediately lower mapping page (relative to the intermediate mapping page) to point to the copied intermediate mapping page, may clear the shared flag of the immediately lower mapping page and may set the shared flag on every mapping table entry of the intermediate mapping page. This step is sequentially and recursively executed for all the intermediate mapping pages of the mapping table 307. Then, the processing resource 302 may copy a highest mapping page corresponding to the highest level of the mapping table 307, the immediately lower mapping page (relative to the highest mapping page) may point to the copied highest mapping page, the highest mapping page may point to the copied physical data block 308 and may clear the shared flag from the immediately lower mapping page. Finally, the processing resource 302 may create a copy of the particular shared physical data block 308, including the corresponding virtual storage volume 309, in a new location on the storage system 301 and may modify the particular physical data block 308 according to the request received.

The process described in the previous paragraph assures the process of copying mapping table metadata pages and setting the shared flag is deferred and done “just-in-time” versus being done up-front when the copy of the original virtual storage volume is created.

In some examples, functionalities described herein in relation to FIG. 2 may be provided in combination with functionalities described herein in relation to any of FIGS. 1 and 3 to 6.

FIG. 3 is a block diagram of an example computing device 300 for creating a virtual storage volume by coping the mapping table for the virtual storage volume. It should be understood that the computing device 300 depicted in FIG. 3 may include additional components and that some of the components described herein may be removed or modified without departing from a scope of the computing device 300. It should be also understood that this example does not intend to be limiting.

Computing device 300 comprises a processor 302 and a storage system 301. Processor 302 may comprise a virtual processor, and/or one or more of: a central processing unit (CPU), digital signal processor (DSP), application-specific integrated circuit (ASIC), field programmable gate array (FPGA), or the like. In various examples, the storage system 301 comprises a database 303 storing the root pointers 306 pointing to the corresponding mapping tables 307 and two partitions, a first partition 304 storing mapping tables 307 of the virtual storage volumes 309 and a second partition 305 storing the physical data blocks 308 that comprise the virtual storage volumes 309. In some examples, each one of the physical data blocks 308 may store a plurality of virtual storage volumes 309.

Storage system 301 is illustrated as a single storage system having different partitions for the purposes of example. However, in some examples, storage system 301 may comprise multiple storage devices, a storage array, storage area network (SAN), one or more virtual storage devices, or any combination thereof. The storage system 301, including the database 303, the mapping tables 304 alongside the data pages for the virtual storage volumes 309 and the physical data blocks 305 may be stored on disk in the computer device 301.

The processor 302 may create an additional root pointer 306 for each one of the existing root pointers 306 of the database 303 and may set the shared flags of the existing and additional root pointers 306 indicating that the mapping tables 307 for the virtual storage volumes 309 to which they point, are shared. These additional root pointers 306 may store an address pointing to the same mapping table 307 than the respective existing root pointers 306. These additional root pointers 306 may be stored in the database 303. The processor 302 may receive a request to modify an existing physical data block 308 that is shared. Then, the processor 302 may check that the root pointers 306 pointing to the mapping table 307 of the virtual storage volume 309 stored in the physical data block 308 have their shared flag set. The processor 302 may create a copy of this shared physical data block 308 in a new location on the second partition 305 of the storage system 301 and may modify this copy according to the request received. Then, the processor 302 may create a copy of the mapping table 307 in the first partition 304 such that the additional root pointer 306 may be pointing to the original mapping table 307 and the original physical data block 308 and the original root pointer 306 may be pointing to the copy of the mapping table 307 and to the copy of the physical data block 308.

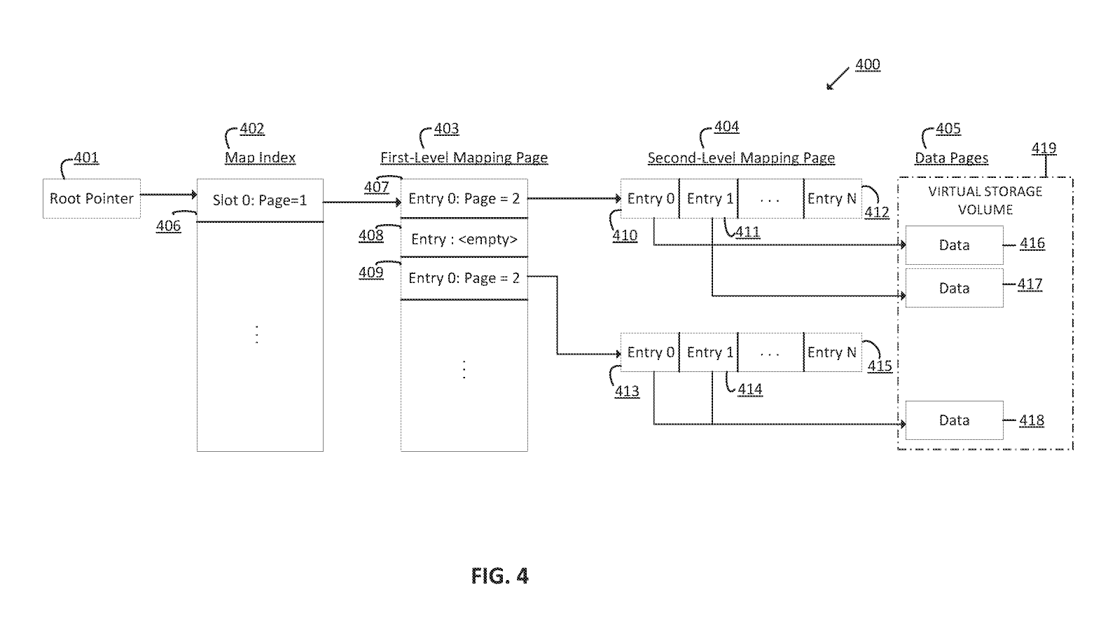

FIG. 4 is a block diagram of an example mapping table 400 pointing to a virtual storage volume. The mapping table may be unequivocally identified by a root pointer 401 in a database of the storage system in a computing device. It should be also understood that this example does not intend to be limiting.

The mapping table 400 is a multi-level mapping table corresponding to one virtual storage volume. The mapping table 400 comprises metadata for mapping data pages 405 forming the virtual storage volume 419. The mapping table 400 has one entry for each page 405 on the virtual storage volume 419. A data page 405 comprises multiple contiguous logical blocks on the virtual storage volume 419. There is a single mapping table entry for each data page in the virtual storage volume. The data in the entry applies to all logical blocks in that page.

The mapping table 400 is organized into a three-level structure: a map index 402, a first-level mapping page 403 and second-level mapping page 404. The mapping table is sparse, with metadata pages allocated dynamically from the pool itself as needed. The entries 406 in the map index 402 store pointers to the beginning of the page storing the data for the first-level mapping page 403, the first-level mapping page 403 store pointers 407-409 to the beginning of the page storing the data for the second-level mapping page 404. The entries 410-415 within the second-level mapping page 404 store mapping information for data pages 405 on the virtual storage volume 419. In some examples, individual second-level mapping entries 410,411 may point to individual underlying data pages 416,417. In some other examples, multiple second-level mapping entries 413,414 may point to the same underlying data page 418.

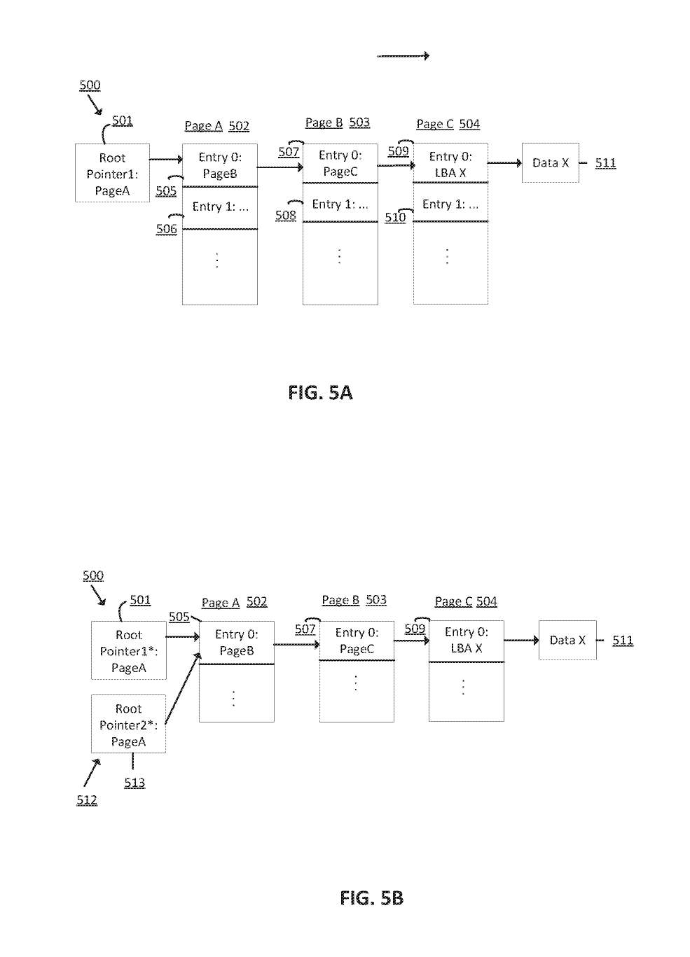

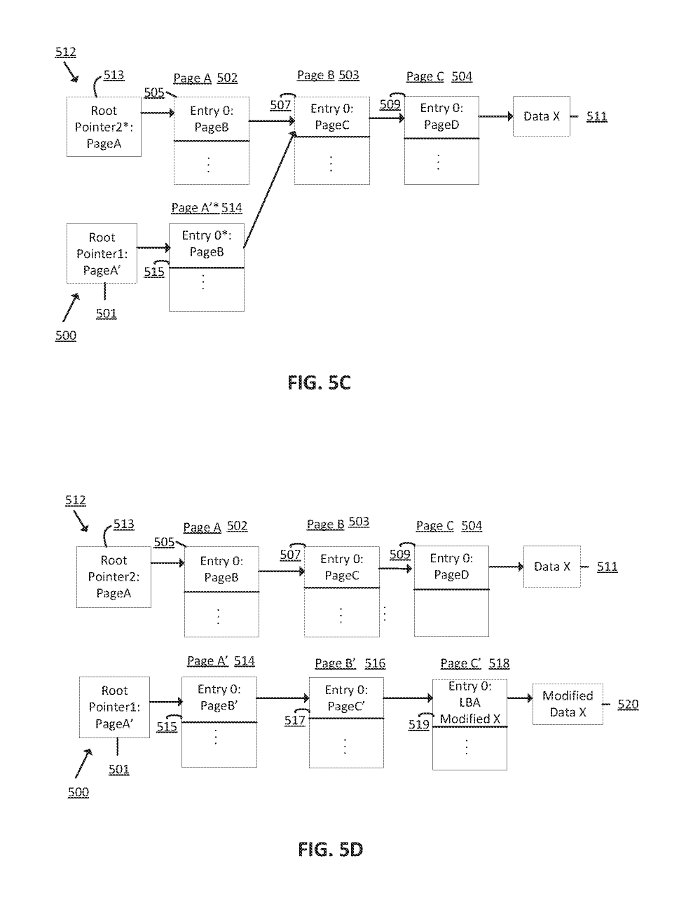

FIGS. 5A-5D are block diagrams of an example method for copying and modifying an existing physical data block by copying the mapping table pointing to the physical data block. Although execution of the method of FIGS. 5A-5D is described in relation to computing device 300 of FIG. 3, it is contemplated that the method of FIGS. 5A-5D may be executed on any suitable system or devices. The method of FIGS. 5A-5D may be implemented as processor-executable instructions stored on a non-transitory computer-readable medium or in the form of electronic circuitry. The specific sequences of operations described in relation to FIGS. 5A-5D are not intended to be limiting, and implementations not containing the particular orders of operations depicted in FIGS. 5A-5D may still be consistent with the examples shown in FIGS. 5A-5D.

FIG. 5A is a block diagram of a first stage of the example method in which a mapping table 500 corresponding to a virtual storage volume “V” 309 is provided. The mapping table 500 is organized into a three-level structure: a first level or “page A” 502, a second level or “page B” 503, and a third level or page “C” 504. Page A 502 corresponds to the lowest level in the mapping table 500 and page C 504 corresponds to the highest level of the mapping table 500. The entries in Page A 502 and Page B 503 of the mapping table 500 store pointers to the beginning of the page storing the data for the next level of the mapping table 500. The entries within the Page C 504 store mapping information for a physical data block 308 comprising the corresponding virtual storage volume 309, the physical data block storing the Data X 511.

More specifically, FIG. 5A includes a “Root Pointer1” 501 storing an address pointing to Page A 502 of the mapping table 500. Page A 502 contains an array of entries 505,506 wherein “Entry 0” 505 stores an address pointing to the beginning of the page storing the data for Page B 503 and other entries 506 may contain addresses to other data pages in the virtual storage volume 309 (there is one single mapping table entry for each page in the virtual storage volume 309). All entries 505,506 in Page A 502 store a shared flag. Page B 503 contains an array of entries 507,508 wherein “Entry 0” 507 stores an address pointing to the beginning of the page storing the data for Page C 504 and other entries 508 may contain addresses to other data pages in the virtual storage volume 309. All entries in Page B 503 also store a shared flag. Page C 504 contains an array of entries 509,510 wherein “Entry 0” 509 stores a logical block address “IBA X” pointing to the beginning of the page storing the data 511 in the physical data block 308 and other entries 508 may contain addresses to the beginning of other data pages storing other data in other physical data blocks. All entries in Page C 504 also store a shared flag.

FIG. 5B is a block diagram illustrating the second step of the process for copying and modifying an existing physical data block by copying the mapping table pointing to the physical data block. This second step comprises creating a snapshot “V′” of virtual storage volume “V” 309. The processing resource 302 creates other root pointer 513, named as “Root pointer2” pointing to the same mapping table 500 than Root Pointer1 501, and more specifically, storing an address pointing to the beginning of the page storing the data for Page A 502 of the mapping table 500. The processing resource 302 will also sets the shared flag on both root pointers 501,513. An asterisk (*) has been used in FIG. 5B-5D to denote that the shared flag is set on the pointer to the denoted element.

FIG. 5C is a block diagram illustrating the third step of the process for copying and modifying an existing physical data block by copying the mapping table pointing to the physical data block. Responsive to the reception in the storage system 301 of a request to write to “LBA X” which falls into Page C 504, the storage system 301 performs a deferred copying operation of original pages A 502, B 503 and C 504, to new pages A′, B′, C′. An apostrophe (′) has been used in FIG. 5C-5D to denote that the denoted element is a copy of the original element. In particular, the storage system 301 copies Page A 502 to new Page A′ 514 with an “Entry 0” 515 that stores an address pointing to the beginning of the page storing the data for page B 503. The address stored in the Root Pointer1 501 is modified to point to the beginning of the page storing the data for Page A′ 514 and the shared flag in Root Pointer1 501 is cleared. The processing resource 302 sets the shared flag in all mapping entries 515 in Page A′ 514.

FIG. 5D is a block diagram illustrating the subsequent steps of the process for copying and modifying an existing physical data block by copying the mapping table pointing to the physical data block. The storage system 301 copies page B 503 to new Page B′ 516, modifies the address stored in Page A′ 514 to point to Page B′ 516, sets the shared flag in all mapping table entries in Page B′ 516 and clears the shared flag on mapping table entry(s) in Page A′ 514 that points to Page B′ 516. Then, the storage system 301 copies Page C 504 to new Page C′ 518, modifies the address stored in “Entry 0” 517 of Page B′ 516 accordingly, sets the shared flag on all mapping entries in Page C′ 518 and clears the shared flag on the mapping table entry in Page B′ 516 that points to Page C′ 518. Then, the storage system copies “Data X” 511 to new page “Modified Data X” 520 and clears the shared flag on the mapping table entry in Page C′ 518 that points to “Modified Data X” 520. Finally, the storage system writes the data received in the request to modify “LBA X” 511 on the virtual storage volume to the new data page “Modified Data X” 520.

So at this point of the process original virtual storage volume “V” has a complete private copy of the mapping table “chain” and “Modified Data X” 520, which contains the original “Data X” 511 from Page D plus any changes from the client. The shared flag in Root Pointer2 would remain set.

The mapping table 515 for the copied virtual storage volume “V” is unchanged. Virtual storage volume “V” still points to the original shared Page A 502 with the shared flag set. If an additional request to modify “Data X” 511 on “V” would be received, it would cause the same copy process to occur again as per above, to new pages A″, B″, C″, D″.

The process herein described can be applied “recursively” as successive levels of the mapping table are modified, in order to ensure that shared data is never modified without first doing a copy-on-write to create a private copy. This application of the process is what actually performs the deferred copy process on the mapping table of the virtual storage volume and on the data blocks.

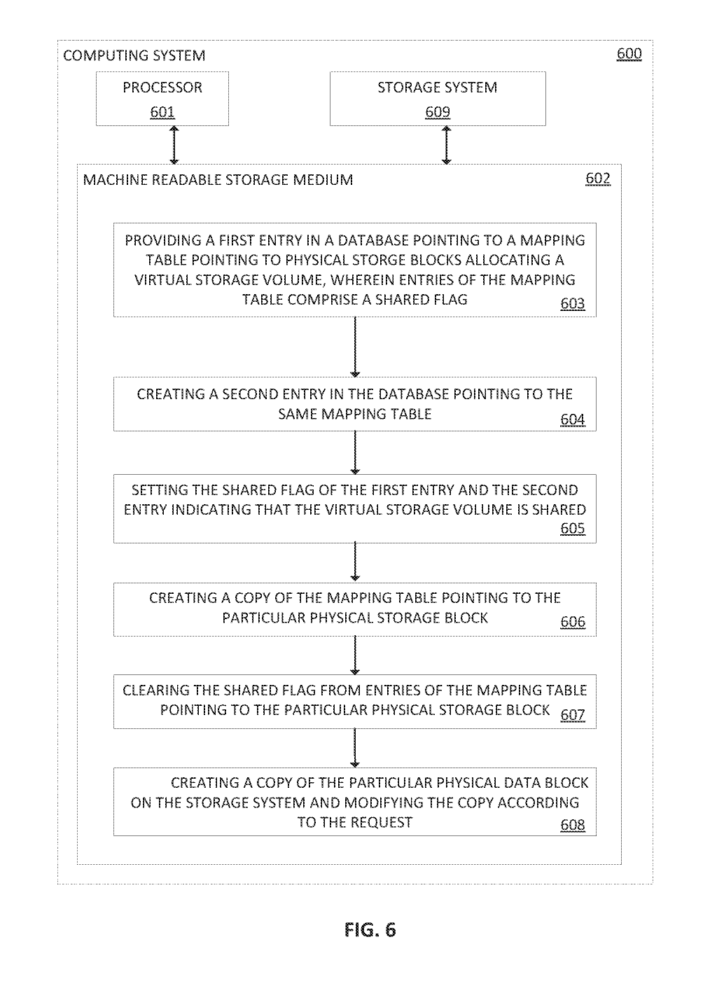

FIG. 6 is a block diagram of an example computing system 600 for creating a virtual storage volume by coping the mapping table pointing to an existing virtual storage volume. It should be understood that the computing system 600 depicted in FIG. 6 may include additional components and that some of the components described herein may be removed or modified without departing from a scope of the computing system 600. It should be also understood that this example does not intend to be limiting.

The computing system 600 is depicted as including an storage system 609 comprising a database with root pointers, mapping tables and physical data blocks stored in physical storage devices, wherein the each root pointer points to a mapping table which in turn points to a single virtual storage volume comprised in a physical data block. The computing system 600 further comprises a machine-readable storage medium 602 and a processor 601. The processor 601 may fetch, decode, and execute instructions, such as the instructions 603-608 stored on the machine-readable storage medium 602.

The processor 601 executes the instructions 603-608 to provide 603 a first entry in the database of the storage system 609 of the computing device 600, wherein the first entry points to a particular mapping table for a virtual storage volume, included in a physical data block, in the storage system and wherein entries in the database and entries of the mapping table comprise a shared flag that when set indicates that a physical data block pointed by the entry is pointed by at least one more entry of a mapping table. The processor 601 further executes the instructions 603-608 to create 604 a second entry in the database pointing to the same mapping table, the second entry also comprising a shared flag, and to set 605 the shared flag of the first and second entries indicating that the virtual storage volume is shared.

The processor 601 further executes the instructions 603-608 to create 606 a copy of the mapping table for the virtual storage volume included in the particular physical data block, wherein entries of the copy of the mapping table point to the copy of the particular physical data block, to clear 607 the shared flag from entries of the mapping table pointing to the particular physical data block and to create 608 a copy of the particular physical data block in a new location on the storage system and modifying the copy of the physical data block according to the request.

As used herein, a “machine-readable storage medium” 602 may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

Processor 601 may fetch, decode, and execute instructions stored on storage medium 602 to perform the functionalities described above in relation to instructions 603-608. In other examples, the functionalities of any of the instructions of storage medium 602 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution.

The solution herein described achieves many technical effects, including the possibility of copying large amounts of metadata and data associated with a virtual storage volume, when a copy of that volume needs to be made. This improves user experience of the storage system by avoiding making the user wait for these copy operations to occur up-front during creation of the copy of the virtual storage volume. This also improves storage utilization in the storage system by making the copy “thin”; that is, any metadata and data pages which are not modified after the copy is created are shared between the copy and the original virtual storage volume. Therefore, the copy only consumes storage resources for pages modified after it is created.

1. A method comprising:
providing, by a processing resource of a computing device, a first entry in a database in an storage system of the computing device, wherein the first entry points to a mapping table pointing to physical data blocks comprising a virtual storage volume in the storage system, wherein entries of the mapping table comprise a shared flag that when set indicates that a physical data block pointed by the entry is pointed by at least one more entry of the mapping table or of another mapping table;
creating, by the processing resource; a second entry in the database pointing to the same mapping table; and
setting, by the processing resource, the shared flag of the first and second entries indicating that the virtual storage volume is shared.

2. The method of claim 1, wherein in response to a request to modify a particular shared physical data block, the method further comprises:
creating a copy of the mapping table pointing to the particular physical data block, wherein entries of the copy of the mapping table point to the copy of the particular physical data block;
clearing the shared flag from entries of the mapping table pointing to the particular physical data block; and
creating a copy of the particular physical data block in a new location on the storage system and modifying the copy of the physical data block according to the request.

3. The method of claim 1, wherein the mapping table of the virtual storage volume is a multi-level mapping table, entries of the multi-level mapping table comprise pointers to an immediately higher level of the multi-level mapping table and entries of a highest level of the mapping table store pointers to the physical data blocks.

4. The method of claim 3, wherein in response to a request to modify a particular shared physical data block, the method further comprises:
copying a lowest mapping page corresponding to a lowest level of the mapping table, the first entry pointing to the copied lowest mapping page, clearing the shared flag from the first entry and setting the shared flag of the copied lowest mapping page;
for each intermediate level of the mapping table, copying the intermediate mapping page corresponding to the intermediate level of the mapping table, am immediately lower mapping page pointing to the copied intermediate mapping page, clearing the shared flag of the immediately lower mapping page and setting the shared flag of the intermediate mapping page;
copying a highest mapping page corresponding to the highest level of the mapping table, the immediately lower mapping page pointing to the copied highest mapping page and the highest mapping page pointing to the modified physical data block, and clearing the shared flag from the immediately lower mapping page; and
creating a copy of the particular physical data block in a new location on the storage system and modifying the copied physical data block according to the request.

5. The method of claim 1, comprising providing, by the processing resource, a plurality of first entries in the database, wherein each one of the first entries points to a mapping table pointing to respective physical data blocks allocating a respective virtual storage volume.

6. The method of claim 5, comprising:
creating, by the processing resource and for each one of the first entries of the database, a corresponding second entry in the database pointing to the same mapping table pointed by the first entry; and
setting, by the processing resource, the shared flag of the respective first and second entries indicating that the corresponding virtual storage volume is shared.

7. The method of claim 1, wherein the first and second entries store an address pointing to the mapping table of the corresponding virtual storage volume.

8. The method of claim 3, wherein the entries of the multi-level mapping table store addresses pointing to an immediately higher level of the multilevel mapping table.

9. The method of claim 8, wherein the addresses point to the beginning of a page chunk storing data for the immediately higher level of the multi-level mapping table.

10. The method of claim 1, wherein the virtual storage volume is a thin-provisioned storage volume.

11. A non-transitory computer-readable medium comprising processor-executable instructions that, when executed cause a processor to:
provide a first entry in a database in an storage system of a computing device, wherein the first entry points to a mapping table pointing to physical data blocks comprising a virtual storage volume in the storage system, wherein entries of the mapping table comprise a shared flag that when set indicates that a physical data block pointed by the entry is pointed by at least one more entry of the mapping table or of another mapping table;
create a second entry in the database pointing to the same mapping table;
set the shared flag of the first and second entries;
receive a request to modify a particular shared physical data block;
copy the mapping table pointing to the particular physical data block, wherein the copied mapping table points to the copy of the particular physical data block;
clear the shared flag from entries of the mapping table pointing to the physical data block; and
create a copy of the particular physical data block and modifying the copied physical data block according to the request.

12. The non-transitory computer-readable medium of claim 11, wherein the instructions to copy the mapping table pointing to the particular physical data block and to clear the shared flag from entries of the mapping table further comprise instructions that when executed cause the processor to:
copy a lowest mapping page corresponding to a lowest level of the mapping table, the first entry pointing to the copied lowest mapping page, clear the shared flag from the first entry and set the shared flag of the copied lowest mapping page;
for each intermediate level of the mapping table, copy the intermediate mapping page corresponding to the intermediate level of the mapping table, am immediately lower mapping page pointing to the copied intermediate mapping page, clear the shared flag of the immediately lower mapping page and set the shared flag of the intermediate mapping page; and,
copy a highest mapping page corresponding to the highest level of the mapping table, the immediately lower mapping page pointing to the copied highest mapping page and the highest mapping page pointing to the modified physical data block, and clear the shared flag from the immediately lower mapping page.

13. The non-transitory computer-readable medium of claim 11, wherein the instructions to provide a first entry in a database comprise further instructions that when executed cause the processor to provide a plurality of first entries in the database, wherein each one of the first entries points to a mapping table pointing to respective physical data blocks allocating a respective virtual storage volume.

14. The non-transitory computer-readable medium of claim 13, wherein the instructions further cause the processor to:
for each one of the first entries of the database, create a corresponding second entry in the database pointing to the same mapping table pointed by the first entry; and
set the shared flag of the respective first and second entries indicating that the corresponding virtual storage volume is shared.

15. The non-transitory computer-readable medium of claim 11, wherein the virtual storage volume is a thin-provisioned storage volume.

16. A computing device comprising:
a storage system comprising a database storing a first entry pointing to a mapping table, the mapping table pointing to physical data blocks comprising a virtual storage volume in the storage system, wherein entries of the mapping table comprise a shared flag that when set indicates that a physical data block pointed by the entry is pointed by at least one more entry of the mapping table or of another mapping table;
a processor to create a second entry in the database pointing to the mapping table and set the shared flag of the first entry and of the second entry.

17. The computing device of claim 16, wherein the processor is further to:
create a copy of the mapping table pointing to the particular physical data block, wherein entries of the copy of the mapping table point to the copy of the particular physical data block;
clear the shared flag from entries of the mapping table pointing to the particular physical data block; and
create a copy of the particular physical data block in a new location on the storage system and modifying the copy of the physical data block according to the request.

18. The computing device of claim 16, wherein the mapping table of the virtual storage volume is a multi-level mapping table, entries of the multi-level mapping table comprise pointers to an immediately higher level of the multi-level mapping table and entries of a highest level of the mapping table store pointers to the physical data blocks.

19. The computing device of claim 16, wherein the shared flag is a bit located in each one of the entries of the mapping table.

20. The computing device of claim 16, wherein the virtual storage volume is a thin-provisioned storage volume.
